(19) United States
(12) Patent Application Publication
(10) Pub. No.: US 2017/0318556 A1
(43) Pub. Date: Nov. 2, 2017

(54) Method and Device for Enhancing Positioning

(71) Applicant: ZTE CORPORATION, Shenzhen City, Guangdong Province (CN)

(72) Inventors: Zhaohua LU, Shenzhen (CN); Bo DAI, Shenzhen (CN); Shijun CHEN, Shenzhen (CN); Yong LI, Shenzhen (CN); Kun LIU, Shenzhen (CN)

(21) Appl. No.: 15/523,678

(22) PCT Filed: Sep. 11, 2015
(86) PCT No.: PCT/CN2015/087941

§ 371 Date: May 2, 2017

(30) Foreign Application Priority Data
Nov. 5, 2014 (CN) 201410619344.0

(51) Int. Cl. H04W 64/00; H04W 72/04; H04L 5/00

(52) U.S. Cl. CPC H04W 64/006; H04L 5/0048; H04W 72/048

(57) ABSTRACT

A method and device for enhancing positioning are provided, the method includes: a first communication node generates a second positioning reference signal; the first communication node sends the second positioning reference signal, herein, one or more of the following parameters of the second positioning reference signal is/are different from that/those of the first positioning reference signal: sequence generation mode, transmission time frequency resource, sending period, transmission power, continuous duration. The above technical scheme can help the positioning system to improve the positioning accuracy.

### TECHNICAL FIELD

The text refers to, but is not limited to, the field of positioning, and more particularly to a method and device for enhancing positioning.

### BACKGROUND

With the continuous development of the times, positioning technology has received more and more attention, higher technical requirements has been put forward on positioning accuracy.

As for Global Position System (GPS) positioning technology, due to reasons such as signal loss, the signal will be weakened indoors, thus the positioning terminal cannot search for enough signals; due to large positioning error, a cellular network system cannot achieve sufficient accuracy either outdoors or indoors, and cannot meet the ever-increasing positioning accuracy requirements.

In order to solve the problem of high-accuracy positioning, a usual way is to establish a wireless positioning system on the ground, each positioning signal station is laid in the near-field, there are a variety of ways for positioning, such as, the use of satellite-based ground pseudo-satellite system, wireless LAN system and etc., herein, the ground pseudo-satellite system requires the mobile phone to deal with the coexistence of terrestrial satellite and space satellite signals, and makes great demands on its frequency dynamic range; the wireless local area network mainly adopts a ranging method based on signal strength, and the positioning accuracy relies heavily on the network density of the layout.

It can be seen that, in order to meet high-accuracy positioning requirement, different positioning systems use different positioning schemes, but the performance of the positioning scheme is easily affected by the change of environmental factor, for example, the positioning accuracy of the method for calculating propagation distance through time such as arrival time, time difference of arrival and so on, is easy to be affected by multi-path channel propagation; the positioning accuracy of the positioning algorithm based on fingerprint such as signal strength, signal statistics information is easily affected by change and movement of objects in the environment; the positioning accuracy of positioning algorithm based on natural characteristics such as gravity field, magnetic field is easily affected by geological changes, universe changes and so on.

### SUMMARY

The following is an overview of the subjects that are described in detail in this text. The summary is not intended to limit the protective scope of the claims.

An embodiment of the present disclosure provides an enhancing positioning scheme to solve a technical problem of improving positioning accuracy for a positioning system.

An embodiment of the present disclosure provides a method for enhancing positioning, including:

a first communication node generating a second positioning reference signal; and

the first communication node sending the second positioning reference signal to a second communication node, herein, one or more of following parameters of the second positioning reference signal is/are different from that/those of the first positioning reference signal which is sent from the first communication node to the second communication node: sequence generation mode, transmission time frequency resource, sending period, transmission power, continuous duration.

In an exemplary embodiment, in a long term evolution (LTE) frame, a subframe set which allows sending of the second positioning reference signal is different from a subframe set which allows sending of the first positioning reference signal.

In an exemplary embodiment, within a physical resource block in a long term evolution frame, a subcarrier which is used for sending the second positioning reference signal is different from a subcarrier which is used for sending the first positioning reference signal.

In an exemplary embodiment, when the second positioning reference signal and the first positioning reference signal are sent on a same subframe in the long term evolution frame, physical resource blocks used are different.

In an exemplary embodiment, the first positioning reference signal is a positioning reference signal in an LTE standard.

In an exemplary embodiment, the method further includes:
the first communication node sending configuration information related to the second positioning reference signal.

In an exemplary embodiment, the configuration information includes at least one of the following:

a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back positioning information generated based on the second positioning reference signal.

In an exemplary embodiment, the second positioning reference signal is sent discretely in one sending period.

In an exemplary embodiment, sending discretely refers to that the second positioning reference signal is sent at equal intervals in the sending period.

An embodiment of the present disclosure provides a method for enhancing positioning, including:

a second communication node receiving a second positioning reference signal sent by a first communication node;

the second communication node performing positioning based on the second positioning reference signal, herein, one or more of following parameters of the second positioning reference signal is/are different from that/those of the first positioning reference signal which is sent from the first communication node to the second communication node:

sequence generation mode, transmission time frequency resource, sending period, transmission power, continuous duration.

In an exemplary embodiment, in a long term evolution frame, a subframe set for receiving and carrying the second positioning reference signal is different from a subframe set for receiving and carrying the first positioning reference signal.

In an exemplary embodiment, within a physical resource block in a long term evolution frame, a subcarrier which is used for receiving the second positioning reference signal is different from a subcarrier which is used for receiving the first positioning reference signal.

In an exemplary embodiment, when the second positioning reference signal and the first positioning reference signal being received on a same subframe in the long term evolution frame, physical resource blocks used are different.

In an exemplary embodiment, the method further includes:
the second communication node performing positioning based on the first positioning reference signal.

In an exemplary embodiment, the first positioning reference signal is a positioning reference signal in an LTE standard.

In an exemplary embodiment, the method further includes:
the second communication node receiving configuration information related to the second positioning reference signal sent by the first communication node.

In an exemplary embodiment, the configuration information includes at least one of the following: a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back positioning information generated based on the second positioning reference signal.

In an exemplary embodiment, the second positioning reference signal is received discretely in one receiving period.

In an exemplary embodiment, receiving discretely refers to that the second positioning reference signal is received at equal intervals in the receiving period.

An embodiment of the present disclosure further provides a device for enhancing positioning, provided in a first communication node, including:

a generating module, configured to: generate a second positioning reference signal; and

a sending module configured to send the second positioning reference signal to a second communication node, herein, one or more of following parameters of the second positioning reference signal is/are different from that/those of the first positioning reference signal which is sent from the first communication node to the second communication node: sequence generation mode, transmission time frequency resource, sending period, transmission power, continuous duration.

In an exemplary embodiment, the sending module is configured to send the second positioning reference signal in the following way that: in a long term evolution frame, a subframe set which allows sending of the second positioning reference signal is different from a subframe set which allows sending of the first positioning reference signal.

In an exemplary embodiment, the sending module is configured to send the second positioning reference signal in the following way that: within a physical resource block in a long term evolution frame, a subcarrier which is used for sending the second positioning reference signal is different from a subcarrier which is used for sending the first positioning reference signal.

In an exemplary embodiment, the sending module is configured to send the second positioning reference signal in the following way that: when the second positioning reference signal and the first positioning reference signal are sent on a same subframe in the long term evolution frame, physical resource blocks used are different.

In an exemplary embodiment, the first positioning reference signal is a positioning reference signal in an LTE standard.

In an exemplary embodiment, the sending module is further configured to send configuration information related to the second positioning reference signal.

In an exemplary embodiment, the configuration information further includes at least one of the following:

a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back the positioning information generated based on the second positioning reference signal.

In an exemplary embodiment, the sending module is configured to send the second positioning reference signal in the following way that: the second positioning reference signal sent by the sending module is sent discretely in one sending period.

In an exemplary embodiment, sending discretely refers to that the sending module sending the second positioning reference signal at equal intervals in the sending period.

An embodiment of the present disclosure further provides a device for enhancing positioning, provided in a second communication node, including:

a receiving module configured to receive a second positioning reference signal sent by a first communication node, herein, one or more of following parameters of the second positioning reference signal is/are different from that/those of the first positioning reference signal which is sent from the first communication node to the second communication node: sequence generation mode, transmission time frequency resource, sending period, transmission power, continuous duration.

a positioning module configured to perform positioning based on the second positioning reference signal.

In an exemplary embodiment, the receiving module is configured to receive the second positioning reference signal in the following way that: in a long term evolution frame, a subframe set for receiving and carrying the second positioning reference signal is different from a subframe set for receiving and carrying the first positioning reference signal.

In an exemplary embodiment, the receiving module is configured to receive the second positioning reference signal in the following way that: within a physical resource block in a long term evolution frame, a subcarrier which is used for receiving the second positioning reference signal is different from a subcarrier which is used for receiving the first positioning reference signal.

In an exemplary embodiment, the receiving module is configured to receive the second positioning reference signal in the following way that: when the second positioning reference signal and the first positioning reference signal are received on a same subframe in the long term evolution frame, physical resource blocks used are different.

In an exemplary embodiment, the positioning module is further configured to perform positioning based on the first positioning reference signal.

In an exemplary embodiment, the first positioning reference signal is a positioning reference signal in an LTE standard.

In an exemplary embodiment, the receiving module is further configured to receive configuration information related to the second positioning reference signal sent by the first communication node.

In an exemplary embodiment, the configuration information includes at least one of the following: a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back positioning information generated based on the second positioning reference signal.

In an exemplary embodiment, the receiving module is configured to receive the second positioning reference signal in the following way that: the second positioning reference signal is received discretely in one sending period.

In an exemplary embodiment, receiving discretely refers to that the second positioning reference signal is received at equal intervals in the receiving period.

An embodiment of the present disclosure provides a computer storage medium, storing computer-executable instructions, herein, the computer-executable instructions are used to execute the abovementioned method.

The enhancing positioning scheme provided by embodiments of the present disclosure can help the positioning system to improve the positioning accuracy, which can provide better location-based services on this basis.

After reading and understanding the drawings and detailed description, other aspects can be understood.

### BRIEF DESCRIPTION OF DRAWINGS

FIG. 1 is a flow chart of a method for enhancing positioning of an embodiment 1.

FIG. 2 is a flow chart of a method for enhancing positioning of an embodiment 2.

FIG. 3 is a schematic diagram of composition modules of a device for enhancing positioning of an embodiment 3;

FIG. 4 is a schematic diagram of composition modules of a device for enhancing positioning of an embodiment 4;

FIG. 5 is a flow chart of an implementation example 1.

FIG. 6 is a flow chart of an implementation example 9.

### DETAILED DESCRIPTION

The technical scheme of the present application will be described in detail in combination with the accompanying drawings and embodiments below.

It needs to be noted that if there is no conflict, embodiments of the present disclosure and the various features in the embodiments can be combined with each other, which are all within the protection scope of the present application. Furthermore, although a logical order is given in flow charts, in some cases, the steps shown or described here may be executed in a different order.

In embodiment 1, a method for enhancing positioning, as shown in FIG. 1, includes:

a first communication node generating a second positioning reference signal; and the first communication node sending the second positioning reference signal to the second communication node.

In the existing technology, the first communication node generates and sends the first positioning reference signal to the second communication node, the first positioning reference signal is a positioning reference signal in a related LTE standard.

Herein, one or more of following parameters of the second positioning reference signal is/are different from that/those of the first positioning reference signal: sequence generation mode, transmission time frequency resource, sending period, transmission power, continuous duration.

In the present embodiment, the first communication node includes a base station, and the second communication node includes a terminal, and the present embodiment is a work flow of the first communication node.

In the embodiment, in a long term evolution frame, a subframe set which allows sending of the second positioning reference signal is different from a subframe set which allows sending of the first positioning reference signal.

In the embodiment, within a physical resource block in a long term evolution frame, a subcarrier which is used for sending the second positioning reference signal is different from a subcarrier which is used for sending the first positioning reference signal.

In the embodiment, when the second positioning reference signal and the first positioning reference signal are sent on the same subframe of the long term evolution frame, the physical resource blocks which are used thereby are different.

In the embodiment, the second communication node performs positioning based on the first positioning reference signal, and/or the second positioning reference signal.

In the embodiment, the method further includes: the first communication node sending configuration information related to the second positioning reference signal.

In the embodiment, the configuration information includes at least one of the following: a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back positioning information generated based on the second positioning reference signal.

In the embodiment, the second positioning reference signal is sent discretely in one sending period.

In the embodiment, sending discretely refers to that the second positioning reference signal is sent at equal intervals in the sending period.

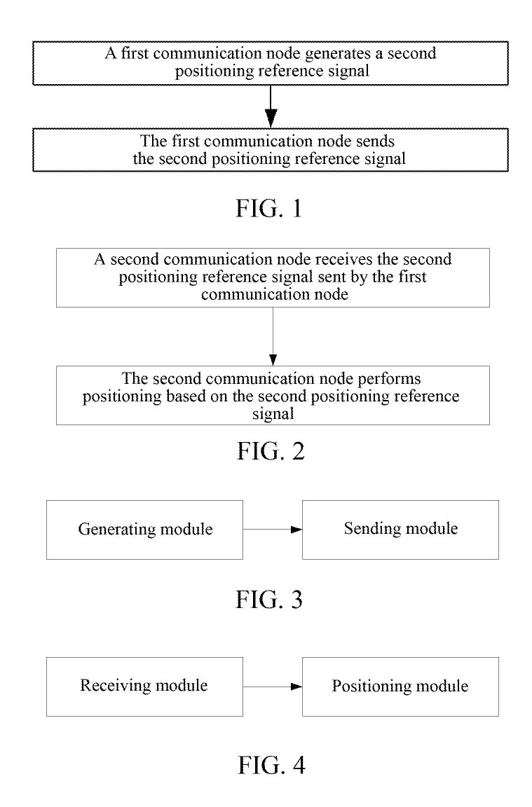

In Embodiment 2, as shown in FIG. 2, a method for enhancing positioning, includes: a second communication node receiving a second positioning reference signal sent by a first communication node; the second communication node performing positioning based on the second positioning reference signal.

In the existing technology, the first communication node generates and sends the first positioning reference signal to the second communication node, the first positioning reference signal is a positioning reference signal in a related LTE standard; the second communication node may select whether to receive the first positioning reference signal.

Herein, one or more of following parameters of the second positioning reference signal are different from that/those of the first positioning reference signal:

sequence generation mode, transmission time frequency resource, sending period, transmission power, continuous duration.

In the present embodiment, the first communication node includes a base station, the second communication node includes a terminal, and the present embodiment is a work flow of a second communication node.

In the embodiment, in a long term evolution frame, a subframe set for receiving and carrying the second positioning reference signal is different from a subframe set for receiving and carrying the first positioning reference signal.

In the embodiment, within a physical resource block in a long term evolution frame, a subcarrier which is used for receiving the second positioning reference signal is different from a subcarrier which is used for receiving the first positioning reference signal.

In the embodiment, when the second positioning reference signal and the first positioning reference signal being received on the same subframe in the long term evolution frame, the physical resource blocks which are used thereby are different.

In the embodiment, the method further includes: the second communication node performing positioning based on the first positioning reference signal.

In an example, the second communication node may perform positioning based on the first positioning reference signal and feed back the positioning result to the first communication node; the first communication node may send the second positioning reference signal according to the positioning result fed back by the second communication node; or an upper network element of the first communication node instructs the first communication node to send the second positioning reference signal according to the positioning result fed back by the second communication node.

In another example, the second communication node may perform positioning based on the first positioning reference signal and instructs the first communication node to send the second positioning reference signal based on the positioning result.

In another example, the second communication node may also receive and perform positioning based on the second positioning reference signal.

In the embodiment, the method further includes: the second communication node receiving configuration information related to the second positioning reference signal sent by the first communication node.

In the embodiment, the configuration information includes at least one of the following: a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back positioning information generated based on the second positioning reference signal.

In the embodiment, the second positioning reference signal is received discretely in one receiving period.

In the embodiment, the discrete receiving refers to that the second positioning reference signal is received at equal intervals in the receiving period.

The embodiment of the present disclosure provides a computer storage medium, storing computer-executable instructions, herein, the computer-executable instructions are used to execute the methods of the above mentioned embodiments.

In Embodiment 3, as shown in FIG. 3, a device for enhancing positioning, provided in a first communication node, includes:

a generating module, configured to: generate a second positioning reference signal; and

a sending module, configured to send the second positioning reference signal to a second communication node.

In the existing technology, the first communication node generates and sends the first positioning reference signal to the second communication node, the first positioning reference signal is a positioning reference signal in a related LTE standard.

Herein, one or more of following parameters of the second positioning reference signal is/are different from that/those of the first positioning reference signal: sequence generation mode, transmission time frequency resource, sending period, transmission power, continuous duration.

In the embodiment, in a long term evolution frame, a subframe set which allows sending of the second positioning reference signal is different from a subframe set which allows sending of the first positioning reference signal.

In the embodiment, within a physical resource block in a long term evolution frame, a subcarrier which is used for sending the second positioning reference signal is different from a subcarrier which is used for sending the first positioning reference signal.

In the embodiment, when the second positioning reference signal and the first positioning reference signal are sent on the same subframe in the long term evolution frame, physical resource blocks used are different.

In the embodiment, the sending module is further configured to send configuration information related to the second positioning reference signal.

In the embodiment, the configuration information further includes at least one of the following:

a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back the positioning information generated based on the second positioning reference signal.

In the embodiment, the second positioning reference signal sent by the sending module is sent discretely in one sending period.

In the embodiment, sending discretely refers to that the sending module sends the second positioning reference signal at equal intervals in the sending period.

In Embodiment 4, as shown in FIG. 4, a device for enhancing positioning, provided in a second communication node, includes:

a receiving module configured to receive the second positioning reference signal sent by the first communication node;

a positioning module configured to perform positioning based on the second positioning reference signal.

In the existing technology, the first communication node generates and sends the first positioning reference signal to the second communication node, the first positioning reference signal is a positioning reference signal in a related LTE standard; the second communication node may select whether to receive the first positioning reference signal.

Herein, one or more of following parameters of the second positioning reference signal are different from that/those of the first positioning reference signal: sequence generation mode, transmission time frequency resource, sending period, transmission power, continuous duration.

In the embodiment, in a long term evolution frame, a subframe set for receiving and carrying the second positioning reference signal is different from a subframe set for receiving and carrying the first positioning reference signal.

In the embodiment, within a physical resource block in a long term evolution frame, a subcarrier which is used for receiving the second positioning reference signal is different from a subcarrier which is used for receiving the first positioning reference signal.

In the embodiment, when the second positioning reference signal and the first positioning reference signal are received on the same subframe in the long term evolution frame, the used physical resource blocks is different.

In the embodiment, the positioning module is further configured to perform positioning based on the first positioning reference signal.

In the embodiment, the receiving module is further configured to receive configuration information related to the second positioning reference signal sent by the first communication node.

In the embodiment, the configuration information includes at least one of the following: a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back positioning information generated based on the second positioning reference signal.

In the embodiment, the second positioning reference signal is received discretely in one receiving period.

In the embodiment, receiving discretely refers to that the second positioning reference signal is received at equal intervals in the receiving period.

To better understand the above mentioned embodiments of the present disclosure, the present application will be further described below in conjunction with accompanying drawings and specific implementation examples.

Implementation examples of base station side

Implementation examples of the embodiment 1 are as follows: herein, the base station is the first communication node and the terminal is the second communication node.

### Implementation Example 1

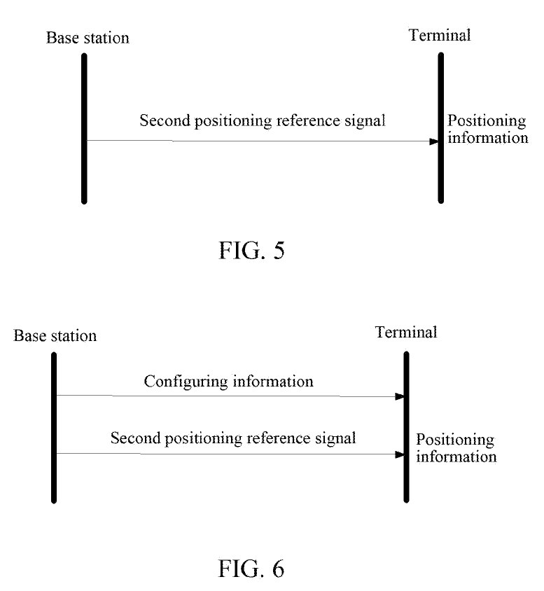

As shown in FIG. 5, the base station generates a second positioning reference signal.

The base station sends a second positioning reference signal, and the sequence generation mode of the second positioning reference signal is different from that of the first positioning reference signal, in the implementation example, the first positioning reference signal is the positioning reference signal in an LTE related standard (e.g., TS 36.211 v920). The second positioning reference signal is a newly added positioning reference signal in embodiments of the present disclosure.

The terminal performs positioning based on the first positioning reference signal and/or the second positioning reference signal, for example, generating position information, error information, information of time difference of arrival of the positioning reference signal related to positioning, and the like.

### Implementation Example 2

The base station generates a second positioning reference signal.

The base station sends a second positioning reference signal, the sequence generation mode and the transmission time frequency resource of the second positioning reference signal are different from those of the first positioning reference signal, in the implementation example, the first positioning reference signal is the positioning reference signal in an LTE related standard (e.g., TS 36.211 v920).

In the implementation example, a subframe set which allows sending of the second positioning reference signal in a long term evolution frame is different from a subframe set which allows sending of the first positioning reference signal.

The terminal performs positioning based on the first positioning reference signal and/or the second positioning reference signal, for example, generating position information, error information, information of time difference of arrival of the positioning reference signal related to positioning, and the like.

### Implementation Example 3

The base station generates a second positioning reference signal. The base station sends a second positioning reference signal, the sequence generation mode and the transmission time frequency resource of the second positioning reference signal are different from those of the first positioning reference signal, in the implementation example, the first positioning reference signal is the positioning reference signal in an LTE related standard (e.g., TS 36.211 v920).

In the implementation example, within a physical resource block in a long term evolution frame, a subcarrier which is used for sending the second positioning reference signal is different from a subcarrier which is used for sending the first positioning reference signal.

The terminal performs positioning based on the first positioning reference signal and/or the second positioning reference signal, for example, generating position information, error information, information of time difference of arrival of the positioning reference signal related to positioning, and the like.

### Implementation Example 4

The base station generates a second positioning reference signal.

The base station sends a second positioning reference signal, the sequence generation mode and the transmission time frequency resource of the second positioning reference signal are different from those of the first positioning reference signal, in the implementation example, the first positioning reference signal is the positioning reference signal in an LTE related standard (e.g., TS 36.211 v920).

In the implementation example, when the second positioning reference signal and the first positioning reference signal are sent on the same subframe of the long term evolution frame, the physical resource blocks used thereby are different.

The terminal performs positioning based on the first positioning reference signal and/or the second positioning reference signal, for example, generating position information, error information, information of time difference of arrival of the positioning reference signal related to positioning, and the like.

### Implementation Example 5

The base station generates a second positioning reference signal.

The base station sends a second positioning reference signal, the sequence generation mode and the sending period of the second positioning reference signal are different from those of the first positioning reference signal, for example, the first positioning reference signal is sent once every five long term evolution frames, the second positioning reference signal is sent once every one long term evolution frame, in the implementation example, the first positioning reference signal is the positioning reference signal in an LTE related standard (e.g., TS 36.211 v920).

The terminal performs positioning based on the first positioning reference signal and/or the second positioning reference signal, for example, generating position information, error information, information of time difference of arrival of the positioning reference signal related to positioning, and the like.

### Implementation Example 6

The base station generates a second positioning reference signal.

The base station sends a second positioning reference signal which is sent discretely in a sending period, in the implementation example, sending discretely refers to that the second positioning reference signal is sent at equal intervals in the sending period, for example, taking every two long term evolution frames as the sending period of the second positioning reference signal, the second positioning reference signal is sent on the sub-frame x, sub-frame (x+n), sub-frame(x+2n) in the first long term evolution frame in each sending period.

The terminal performs positioning based on the first positioning reference signal and/or the second positioning reference signal, for example, generating position information, error information, information of time difference of arrival of the positioning reference signal related to positioning, and the like.

### Implementation Example 7

The base station generates a second positioning reference signal.

The base station sends a second positioning reference signal, and the transmission power of the second positioning reference signal is greater than that of the first positioning reference signal, in the implementation example, the first positioning reference signal is the positioning reference signal in an LTE related standard (e.g., TS 36.211 v920).

The terminal performs positioning based on the first positioning reference signal and/or the second positioning reference signal, for example, generating position information, error information, information of time difference of arrival of the positioning reference signal related to positioning, and the like.

### Implementation Example 8

The base station generates a second positioning reference signal.

The base station sends a second positioning reference signal, the continuous duration of the second positioning reference signal is different from that of the first positioning reference signal, for example, the continuous duration of the first positioning reference signal within every period is 6 subframes, the continuous duration of the second positioning reference signal within every period is 8 subframes, in the implementation example, the first positioning reference signal is the positioning reference signal in an LTE related standard (e.g., TS 36.211 v920).

The terminal performs positioning based on the first positioning reference signal and/or the second positioning reference signal, for example, generating position information, error information, information of time difference of arrival of the positioning reference signal related to positioning, and the like.

### Implementation Example 9

As shown in FIG. 6, the base station generates a second positioning reference signal.

The base station sends the configuration information related to the second positioning reference signal, in the implementation example, the configuration information includes at least one of the following: a frequency domain resource location for sending the second positioning reference signal, a sending period of the second positioning reference signal, a generation mode of the second positioning reference signal, a continuous duration of the second positioning reference signal, a feedback mode of the positioning information based on the second positioning reference signal, and a time-frequency resource for feeding back positioning information based on the second positioning reference signal.

The base station sends the second positioning reference signal.

The terminal receives the second positioning reference signal and performs positioning based on the configuration information, for example, generating position information, error information, information of time difference of arrival of the positioning reference signal related to positioning, and the like.

Implementation Examples of Terminal Side

### Implementation Example 10

The terminal receives the second positioning reference signal from the base station, performs positioning based on the second positioning reference signal and/or the first positioning reference signal, for example, generating position information, error information, information of time difference of arrival of the positioning reference signal related to positioning, and the like.

The sequence generation mode of the second positioning reference signal is different from that of the first positioning reference signal, in the implementation example, the first positioning reference signal is the positioning reference signal in an LTE related standard (e.g., TS 36.211 v920).

### Implementation Example 11

The terminal receives the second positioning reference signal from the base station, performs positioning based on the second positioning reference signal and/or the first positioning reference signal, for example, generating position information, error information, information of time difference of arrival of the positioning reference signal related to positioning, and the like.

The sequence generation mode and the transmission time frequency resource of the second positioning reference signal are different from those of the first positioning reference signal, in the implementation example, the first positioning reference signal is the positioning reference signal in an LTE related standard (e.g., TS 36.211 v920).

In the implementation example, in a long term evolution frame, a subframe set which allows sending of the second positioning reference signal is different from a subframe set which allows sending of the first positioning reference signal.

### Implementation Example 12

The terminal receives the second positioning reference signal from the base station, performs positioning based on the second positioning reference signal and/or the first positioning reference signal, for example, generating position information, error information, information of time difference of arrival of the positioning reference signal related to positioning, and the like.

The sequence generation mode and the transmission time frequency resource of the second positioning reference signal are different from those of the first positioning reference signal, in the implementation example, the first positioning reference signal is the positioning reference signal in an LTE related standard (e.g., TS 36.211 v920).

In the implementation example, within a physical resource block in a long term evolution frame, a subcarrier which is used for sending the second positioning reference signal is different from a subcarrier which is used for sending the first positioning reference signal.

### Implementation Example 13

The terminal receives the second positioning reference signal from the base station, performs positioning based on the second positioning reference signal and/or the first positioning reference signal, for example, generating position information, error information, information of time difference of arrival of the positioning reference signal related to positioning, and the like.

The sequence generation mode and the transmission time frequency resource of the second positioning reference signal are different from those of the first positioning reference signal, in the implementation example, the first positioning reference signal is the positioning reference signal in an LTE related standard (e.g., TS 36.211 v920).

In the implementation example, when the second positioning reference signal and the first positioning reference signal are received on the same subframe in the long term evolution frame, physical resource blocks used thereby are different.

### Implementation Example 14

The terminal receives the second positioning reference signal from the base station, performs positioning based on the second positioning reference signal and/or the first positioning reference signal, for example, generating position information, error information, information of time difference of arrival of the positioning reference signal related to positioning, and the like.

The sequence generation mode and the sending period of the second positioning reference signal are different from those of the first positioning reference signal, in the implementation example, the first positioning reference signal is the positioning reference signal in an LTE related standard (e.g., TS 36.211 v920).

### Implementation Example 15

The terminal receives the second positioning reference signal from the base station, performs positioning based on the second positioning reference signal and/or the first positioning reference signal, for example, generating position information, error information, information of time difference of arrival of the positioning reference signal related to positioning, and the like.

The second positioning reference signal is received discretely in a receiving period, in the implementation example, receiving discretely refers to that the second positioning reference signal is received at equal intervals in the receiving period, for example, taking every two long term evolution frames as the receiving period of the second positioning reference signal, and the second positioning reference signal is received on the sub-frame x, sub-frame (x+n), sub-frame(x+2n) in the first long term evolution frame in each receiving period.

### Implementation Example 16

The terminal receives the second positioning reference signal from the base station, performs positioning based on the second positioning reference signal and/or the first positioning reference signal, for example, generating position information, error information, information of time difference of arrival of the positioning reference signal related to positioning, and the like.

The transmission power of the second positioning reference signal is larger than that of the first positioning reference signal, in the implementation example, the first positioning reference signal is the positioning reference signal in an LTE related standard (e.g., TS 36.211 v920).

The terminal performs positioning based on the first positioning reference signal and/or the second positioning reference signal, for example, generating position information, error information, information of time difference of arrival of the positioning reference signal related to positioning, and the like.

### Implementation Example 17

The terminal receives the second positioning reference signal from the base station, performs positioning based on the second positioning reference signal and/or the first positioning reference signal, for example, generating position information, error information, information of time difference of arrival of the positioning reference signal related to positioning, and the like.

The continuous duration of the second positioning reference signal is different from that of the first positioning reference signal, for example, the continuous duration of the first positioning reference signal within every period is 6 subframes, the continuous duration of the second positioning reference signal within every period is 8 subframes, in the implementation example, the first positioning reference signal is the positioning reference signal in an LTE related standard (e.g., TS 36.211 v920).

The terminal performs positioning based on the first positioning reference signal and/or the second positioning reference signal, for example, generating position information, error information, information of time difference of arrival of the positioning reference signal related to positioning, and the like.

### Implementation Example 18

The terminal receives the configuration information related to the second positioning reference signal from the base station, in the implementation example, the configuration information includes at least one of the following: a frequency domain resource location for sending the second positioning reference signal, a sending period of the second positioning reference signal, a generation mode of the second positioning reference signal, a continuous duration of the second positioning reference signal, a feedback mode of the positioning information based on the second positioning reference signal, and a time-frequency resource for feeding back positioning information based on the second positioning reference signal.

The base station sends the second positioning reference signal.

The terminal receives the second positioning reference signal according to the configuration information, performs positioning according to the first positioning reference signal and/or the second positioning reference signal, for example, position information, error information, information of time difference of arrival of the positioning reference signal related to positioning, and the like.

Implementation Examples of Base Station Side and Terminal Side

### Implementation Example 19

The base station sends the configuration information of the second positioning reference signal.

The base station sends the second positioning reference signal.

The terminal receives the configuration information and receives the second positioning reference signal.

The terminal performs positioning based on the first positioning reference signal and/or the second positioning reference signal, for example, generating position information, error information, information of time difference of arrival of the positioning reference signal related to positioning, and the like. In the implementation example, the first positioning reference signal is the positioning reference signal in an LTE related standard (e.g., TS 36.211 v920).

It should be noted that, in all of the above implementation examples, it is preferable that the terminal needs to explicitly or implicitly inform the base station that the terminal itself generates the feedback information based on the first positioning reference signal, or the second positioning reference signal, or the first positioning reference signal and the second positioning reference signal, for example, a different feedback channel, or a different feedback time-frequency resource, or a different code word sequence corresponds to a different feedback information generation mode, or the base station is informed of a specific way for generating the feedback information directly through the signaling.

The above is detailed descriptions of the present disclosure that is made in combination with specific embodiments, and it is not intended that the specific embodiments of the present disclosure are only limited to these descriptions.

Those skilled in the art can understand that all or part of steps of the above-mentioned embodiments can be implemented using computer program processes. The computer program can be stored in one computer readable storage medium. The computer program is executed on a corresponding hardware platform (e.g., system, equipment, apparatus, device, etc.), and when the computer program is executed, one of steps of the method embodiments or the combination thereof is included.

Alternatively, all or part of steps of the above-mentioned embodiments can also be implemented using integrated circuits, these steps can be fabricated into individual integrated circuit modules respectively, or multiple modules or steps of them are fabricated into a single integrated circuit to implement.

Devices/functional modules/functional units in the above-mentioned embodiments can be implemented using a general-purpose computing device, they can be centralized on a single computing device, or distributed on a network which consists of multiple computing devices.

Devices/functional modules/functional units in the above-mentioned embodiments are implemented in the form of software functional module, and when sold or used as a separate product, it can be stored in one computer readable storage medium. The above-mentioned computer readable storage medium can be read-only memory, disk or compact disc, etc.

### INDUSTRIAL APPLICABILITY

The above technical solution can help the positioning system to improve the positioning accuracy, which can provide better location-based services on this basis.

What is claimed is:

1. A method for enhancing positioning, comprising:
a first communication node generating a second positioning reference signal; and
the first communication node sending the second positioning reference signal to a second communication node, wherein, one or more of following parameters of the second positioning reference signal is/are different from that/those of the first positioning reference signal which is sent from the first communication node to the second communication node:
sequence generation mode, transmission time frequency resource, sending period, transmission power, continuous duration.

2. The method of claim 1, wherein,
in a long term evolution frame, a subframe set which allows sending of the second positioning reference signal is different from a subframe set which allows sending of the first positioning reference signal.

3. The method of claim 1, wherein,
within a physical resource block in a long term evolution frame, a subcarrier which is used for sending the second positioning reference signal is different from a subcarrier which is used for sending the first positioning reference signal.

4. The method of claim 1, wherein,
when the second positioning reference signal and the first positioning reference signal are sent on a same subframe in the long term evolution frame, physical resource blocks used are different.

5. (canceled)

6. (canceled)

7. The method of claim 16, wherein, the configuration information comprises at least one of the following:
a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back positioning information generated based on the second positioning reference signal.

8. (canceled)

9. (canceled)

10. A method for enhancing positioning, comprising:
a second communication node receiving a second positioning reference signal sent by a first communication node;
the second communication node performing positioning based on the second positioning reference signal, wherein, one or more of following parameters of the second positioning reference signal is/are different from that/those of the first positioning reference signal which is sent from the first communication node to the second communication node:
sequence generation mode, transmission time frequency resource, sending period, transmission power, continuous duration.

11. The method of claim 10, wherein:
in a long term evolution frame, a subframe set for receiving and carrying the second positioning reference signal is different from a subframe set for receiving and carrying the first positioning reference signal.

12. The method of claim 10, wherein,
within a physical resource block in a long term evolution frame, a subcarrier which is used for receiving the second positioning reference signal is different from a subcarrier which is used for receiving the first positioning reference signal.

13. (canceled)

14. (canceled)

15. (canceled)

16. (canceled)

17. The method of claim 10, wherein, the configuration information comprises at least one of the following: a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back positioning information generated based on the second positioning reference signal.

18. (canceled)

19. (canceled)

20. A device for enhancing positioning provided in a first communication node, comprising:
a generating module, configured to: generate a second positioning reference signal; and
a sending module configured to send the second positioning reference signal to a second communication node, wherein, one or more of following parameters of the second positioning reference signal is/are different from that/those of the first positioning reference signal which is sent from the first communication node to the second communication node: sequence generation mode, transmission time frequency resource, sending period, transmission power, continuous duration.

21. The device according to claim 20, wherein, the sending module is configured to send the second positioning reference signal in the following way that:
in a long term evolution frame, a subframe set which allows sending of the second positioning reference signal is different from a subframe set which allows sending of the first positioning reference signal.

22. The device according to claim 20, wherein, the sending module is configured to send the second positioning reference signal in the following way that:
within a physical resource block in a long term evolution frame, a subcarrier which is used for sending the second positioning reference signal is different from a subcarrier which is used for sending the first positioning reference signal.

23. (canceled)

24. (canceled)

25. (canceled)

26. The device according to claim 2025, wherein, the configuration information comprises at least one of the following:
a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back the positioning information generated based on the second positioning reference signal.

27. (canceled)

28. (canceled)

29. A device for enhancing positioning enhancement provided in a second communication node, comprising:
a receiving module configured to receive a second positioning reference signal sent by a first communication node, wherein, one or more of following parameters of the second positioning reference signal is/are different from that/those of the first positioning reference signal which is sent from the first communication node to the second communication node: sequence generation mode, transmission time frequency resource, sending period, transmission power, continuous duration;
a positioning module configured to perform positioning based on the second positioning reference signal.

30. The device of claim 29, wherein, the receiving module is configured to receive the second positioning reference signal in the following way that:
in a long term evolution frame, a subframe set for receiving and carrying the second positioning reference signal is different from a subframe set for receiving and carrying the first positioning reference signal.

31. The device of claim 29, wherein the receiving module is configured to receive the second positioning reference signal in the following way that:
within a physical resource block in a long term evolution frame, a subcarrier which is used for receiving the second positioning reference signal is different from a subcarrier which is used for receiving the first positioning reference signal.

32. (canceled)

33. The device according to claim 29, wherein
the positioning module is further configured to perform positioning based on the first positioning reference signal.

34. (canceled)

35. (canceled)

36. The device according to claim 29, wherein:
the configuration information comprises at least one of the following: a frequency domain resource location for sending the second positioning reference signal, a sending period of the second positioning reference signal, a generation mode of the second positioning reference signal, a continuous duration of the second positioning reference signal, a feedback mode of the positioning information generated based on the second positioning reference signal, and a time-frequency resource for feeding back positioning information generated based on the second positioning reference signal.

37. (canceled)

38. (canceled)

39. (canceled)

40. (canceled)
